(19) United States
(12) Patent Application Publication
(10) Pub. No.: US 2024/0268561 A1
(43) Pub. Date: Aug. 15, 2024

(54) SPECIAL EFFECTS ENTERTAINMENT SYSTEM

(71) Applicant: Lumma, LLC., North Hollywood, CA (US)

(72) Inventors: Sebastian Franco, North Hollywood, CA (US); Marcos Franco, North Hollywood, CA (US)

(21) Appl. No.: 18/568,376

(22) PCT Filed: Aug. 19, 2021
(86) PCT No.: PCT/US21/46706

§ 371 Date: Dec. 8, 2023

(51) Int. Cl. A47C 7/72

(52) U.S. Cl. CPC A47C 7/72

(57) ABSTRACT

A multi-functional, integrated chair and controller layout that expands the experiences of watching TV, playing a video game, sharing a video, watching a live event, or relaxing. A chair that delivers movements and special effects such as vibration, wind, aroma, air, lights, and/or water to several entertainment and relaxation experiences. The chair contains all the effects and the systems to generate these effects included in its structure, simplifying its installation and transfer, and supplying a plug and play solution. The chair is essentially designed for home installation, being synchronized with an audiovisual content and receives and executes commands with effects. It concentrates the potential of a 4D experience and also applies it to a gaming chair (gamer) and to a relaxing chair. The present disclosure also provides a method of operating the entertainment system in at least four modes and comprises one or more boxes for generating environmental special effects.

The present disclosure relates to an entertainment and resting entertainment system with special effects formed by one or more chairs comprising movement and special effects, as well as a method of operating the entertainment system and an entertainment system of boxes for generating environmental special effects. In some embodiments, the system of the disclosure comprises an integrated and multifunctional chair that expands the experiences of watching TV, a movie or any audiovisual content, playing a video game, sharing a video, piloting a simulator, watching a live event or simply relaxing and resting. In some embodiments, the system includes a chair that delivers movements of two or more degrees of freedom and special effects such as vibration, wind, aroma, air, lights, water, etc., in a great amount of entertainment and relaxation experiences. The system also comprises a user console that manages the system.

In some embodiments, the chair of the entertainment system of the present disclosure contains all the effects and the systems to generate said effects such as air compressor, water container, light sources, etc. included in its structure, simplifying its installation and transportation in a plug and play solution (immediate connection and use).

The chair of the entertainment system of the present disclosure is synchronized with an audiovisual content, receiving and executing commands of motion and special effects. It links the features of 4D chairs and also applies it to a gamer armchair, a relaxing chair and a chair for live events. The chair of the present disclosure is a chair designed essentially for homes. The term “4D,” is a term that may be used to describe a system, a chair, or another entertainment product combining audio and video content with physical special effects that occur in the environment in synchronization with the content.

### SUMMARY

An aspect of the present disclosure is directed to an entertainment system for use with a plurality of audiovisual sources and comprising one or more special effects chairs. Each special effects chair (23) comprises a body including a seat (72); a motion platform (21) connected to the seat (72); at least one special effects cabinet (20) contained in a portion of the body of the chair; a controller (74) in communication with the motion platform (21), with the at least one special effects cabinet (20) for generating special effects, and with the selected audiovisual source (35, 36); the controller (74) being configured to receive an input signal based on an audiovisual signal from the selected audiovisual source (35, 36) and to send a set of synchronized signals to the motion platform (21) and to the at least one special effects cabinet (20) in response to the received audiovisual signal.

In some embodiments, each special effects cabinet (20) generates all the special effects free of requiring external special effects devices.

In some embodiments, the system further comprises a user console (34) configured to communicate with the selected audiovisual sources (35, 36) to receive one or more selected audiovisual signals therefrom, and to simultaneously send said input signals to the controller (74) of each of the one or more chairs in response to the audiovisual signals received from said selected audiovisual sources (35, 36).

In some embodiments, each special effects cabinet (20) generates all the special effects in an autonomous way, that is, free of requiring external special effects devices for supplying these. In some embodiments, the special effects cabinet (20) generates an aroma effect, a water spray effect, a wind effect, a light effect, a smoke effect, an air impact effect and/or another effect.

In some embodiments, the special effects system further comprise a user console (34) configured to communicate with the selected audiovisual sources (35, 36) to receive one or more selected audiovisual signals therefrom, and to simultaneously send said input signals to the controller (74) of each of the one or more chairs in response to the audiovisual signals received from said selected audiovisual sources (35, 36).

In some embodiments, each chair (23) further comprises: a backrest (13), two armrests (41), a footrest (24), an AC power cable (38) and a base (78).

In some embodiments, each special effects cabinet (20) comprises a set of special effects generators comprising: an aroma effect generator, a water spray effect generator, a wind effect generator and a light generator.

In some embodiments, the set of special effects generators further comprises a smoke effect generator.

In some embodiments, the set of special effects generators further comprises an air impact effect generator.

In some embodiments, the set of special effects generators further comprises a smoke effects generator and an air impact effects generator.

In some embodiments, the aroma effect generator and the air impact effect generator share an air compressor (6) for generating pressure and air volume, and wherein the air impact effect generator further comprises an air container (49).

In some embodiments, said smoke effect generator comprises a water tank (3) to store water, and wherein the water tank (3) contains an ultrasonic transducer (63) inserted into a water floating device (64); wherein said ultrasonic transducer (63) vibrates at an ultrasonic frequency breaking the water particles in the water tank (3) to generate mist that simulates smoke; and wherein the smoke effect generator also comprises a turbine blower (1) that pushes the mist towards a conduit (53) connected to an air outlet port (2) in the special effects cabinet (20).

In some embodiments, the smoke effect generator shares the water tank (3) with the water spray effect generator.

In some embodiments, the smoke effect generator shares the turbine blower (1) with the aroma effect generator and with the wind effect generator.

In some embodiments, said base (78) has a supportive surface that provides stability to the chair (23) against the forces exerted by the motion platform (21) over its entire range of motion, preventing the chair from tipping over, thereby freeing the chair (23) from the need of being anchored to the ground or fastened to any structure.

In some embodiments, the system further comprises one or more environmental special effects generator boxes (173), wherein each of said one or more environmental special effects generator boxes (173) contains one or more environmental special effects generators, wherein said environmental special effects are generated in synchronism with an audio or video signal; and wherein said environmental special effects are generated entirely within the one or more environmental special effects generator boxes (173) in an autonomous way, that is, free of requiring external devices.

In some embodiments, said one or more environmental special effects generator boxes (173) receive the synchronization signal to generate said environmental special effects from said user console (34) or from at least one external device; wherein said at least one external device is selected from the group formed by, but not limited to: PCs, laptops, smartphones, smartwatches, tablets and game consoles (36).

In some embodiments, the user console (34) is configured to communicate with devices selected from the group formed by, but not limited to: said chairs, said one or more environmental special effects boxes (173), and audiovisual sources comprising external devices selected from a group formed by, but not limited to: personal computers (PCs), laptops, game consoles, smartphones, smartwatches, tablets and virtual reality headsets (35, 36).

In some embodiments, the user console (34) is configured to store and play-back audio and video content, run video game software and store pre-programmed cycles to produce movements and to trigger special effects, in the one or more chairs.

In some embodiments, the user console (34) communicates through an internet connection with digital platforms of audio and video contents.

In some embodiments, the user console (34) is configured to create and edit movement schedules and to create and edit timing sequences of special effects trigger commands for the one or more chairs, and is configured for allowing the entertainment system to share said schedules and sequences with other identical entertainment systems in other locations, via the internet or mobile phone communications.

In some embodiments, the position of the backrest (13) and the footrest (24) are adjustable.

In some embodiments, said backrest (13) contains vibration generating devices (18) and contains two air nozzles (17) for the air impact generator device; and wherein said seat (72) contains vibration generating devices (25).

In some embodiments, each chair (23) comprises one or more special effects cabinets (20), wherein each of said one or more special effects cabinets (20) contains one or more special effects generators, wherein said special effects are generated in synchronism with an audio or video signal; and wherein said special effects are generated entirely within the one or more special effects cabinets (20) in an autonomous way, that is, free of requiring external special effects devices.

In some embodiments, said one or more special effects cabinets (20) receive the synchronization signal to generate said special effects from a user console (34) or from at least one external device (36); wherein said at least one external device is selected from the group formed by, but not limited to: PCs, laptops, smartphones, smartwatches, tablets and game consoles (36).

In some embodiments, the entertainment system further comprises one or more environmental special effects generator boxes (173), wherein each of said one or more environmental special effects generator boxes (173) contains one or more environmental special effects generators, wherein said environmental special effects are generated in synchronism with an audio or video signal; and wherein said environmental special effects are generated entirely within the one or more environmental special effects generator boxes (173) in an autonomous way, that is, free of requiring external devices.

In some embodiments, said one or more environmental special effects generator boxes (173) receive the synchronization signal to generate said environmental special effects from a user console (34) or from at least one external device; wherein said at least one external device is selected from the group formed by, but not limited to: PCs, laptops, smartphones, smartwatches, tablets and game consoles (36).

In some embodiments, each of the motion platform (21), the backrest (13), the seat (72), the armrests (41), the special effects cabinet (20), the electronic controller unit (74) and the base (78) form altogether an electrically and mechanically linked device, said one or more chairs being free from the need of being assembled by a user and free of the need of a special electrical or mechanical infrastructure for their operation, making it suitable for its use in a home.

In some embodiments, said motion platform (21) of each of the one or more chairs comprises an electric motion arrangement (44) that moves the chair (23),

In some embodiments, each chair (23) is configured to operate in three different hardware configurations: (i) configuration with a user console (34); (ii) configuration with a PC or a game console; (iii) configuration with a mobile device.

In some embodiments, (i) the hardware configuration with a user console (34) includes at least one chair (23) connected to a user console (34); and comprises communication with a display device (29) selected from the group consisting of, but not limited to: TV, smart TV, monitor, video projector and virtual reality headset; (ii) in the hardware configuration with a PC or a game console, the one or more chairs are connected to the PC or game console; and (iii) in the hardware configuration with a mobile device, the one or more chairs are connected directly to a mobile device selected from the group consisting of, but not limited to: smartphones and smartwatches, tablets and virtual reality headsets (35).

In some embodiments, each of the one or more chairs further comprises a socket (22); wherein said socket (22) is configured for the mounting of a removable accessory support (37) for attaching different peripherals and commercial controls for software simulators and video games, selected from the group formed by, but not limited to: steering wheels, pedals, gear-shifters, airplane controls, joysticks and displays; and for allowing those said peripherals and game controls to accompany the movement of the chair (23) in its motion, turning the chair into a simulator with movements and effects.

In some embodiments, each chair (23) comprises two special effects cabinets (20).

In some embodiments, the special effects are generated by the special effects box (20) or the environmental special effects cabinet (173), or both (20, 173).

Another aspect of the present disclosure is directed to a special effects chair for use with a plurality of audiovisual sources. The chair (23) comprises a body including a seat (72); a motion platform (21) connected to the seat (72); and at least one special effects cabinet (20) housed in a portion of the body of the chair and including a controller (74) configured to selectively communicate with one of the plurality of audiovisual sources (36), said controller (74) being in communication with the motion platform (21), with the at least one special effects cabinet (20) and with the selected audiovisual source (36), the controller (74) being configured to receive an input signal based on an audiovisual signal from the selected audiovisual source (36) and to send a set of synchronized signals to the motion platform (21) and to the at least one special effects cabinet (20) in response to the received audiovisual signal; wherein each special effects cabinet (20) generates all the special effects free of requiring external special effects devices.

Another aspect of the present disclosure is directed to an environmental special effects box (173) for use with a plurality of audiovisual sources, and with a user console (34). The environmental special effects box (173) comprises a set of environmental special effects generators; a controller (111) configured to selectively communicate with one of the plurality of audiovisual sources (36) and with the user console (34), said controller (111) being configured to receive an input signal based on an audiovisual signal from the selected audiovisual source (36) or from the user console (34) and to send a set of synchronized signal to the set of environmental special effects contained therein in response to the received audiovisual signal or the received signal from the console (34); wherein the set of environmental special effects generates all the environmental special effects free of external special effects devices; wherein said set of environmental special effect generators contained in each of the one or more environmental special effects generator boxes (173) comprise: an environmental smoke effect generator, an environmental light effect generator and an environmental wind effect generator; wherein said environmental smoke effect generator comprises a water tank (103) to store water, and wherein the water tank (103) contains an ultrasonic transducer (163) inserted into a floating device (164) and wherein the ultrasonic transducer (163) vibrates at an ultrasonic frequency breaking the water particles in the water tank (103) to generate mist that simulates smoke; and wherein the environmental smoke effect generator also comprises a turbine blower (101) that pushes the mist to an air outlet port (102) of the environmental special effects box (173); wherein the environmental special effects generator box (173) generates all the special effects free of requiring external special effects devices.

In some embodiments, the set of environmental special effect generators further comprises an environmental aroma effect generator.

Another aspect of the present disclosure is directed to an environmental special effects box (173) for use with a plurality of audiovisual sources, and with a user console (34). The environmental special effects box (173) comprises a set of environmental special effects generators; a controller (111) configured to selectively communicate with one of the plurality of audiovisual sources (36) and with the user console (34), said controller (111) being configured to receive an input signal based on an audiovisual signal from the selected audiovisual source (36) or from the user console (34) and to send a set of synchronized signals to the set of environmental special effects contained therein in response to the received audiovisual signal or the received signal from the console (34). Said set of environmental special effect generators contained in each of the one or more environmental special effects generator boxes (173) comprise: an environmental smoke effect generator, an environmental light effect generator and an environmental wind effect generator. Said environmental smoke effect generator comprises a water tank (103) to store water, and wherein the water tank (103) contains an ultrasonic transducer (163) inserted into a floating device (164) and wherein the ultrasonic transducer (163) vibrates at an ultrasonic frequency breaking the water particles in the water tank (103) to generate mist that simulates smoke; and wherein the environmental smoke effect generator also comprises a turbine blower (101) that pushes the mist to an air outlet port (102) of the environmental special effects box (173).

In some embodiments, the set of environmental special effects generators generates all the environmental special effects free of external special effects devices.

In some embodiments, the set of environmental special effect generators further comprises an environmental water spray effect generator.

In some embodiments, the set of environmental special effect generators further comprises environmental aroma effect generator and an environmental water spray effect generator.

In some embodiments, the environmental smoke effect generator shares the water tank (103) with the environmental water spray effect generator.

In some embodiments, the environmental smoke effect generator shares the turbine blower (101) with the environmental aroma effect generator and with the environmental wind effect generator.

Another aspect of the present disclosure is directed to a method of providing a special effects system for use with a plurality of audiovisual sources, the system comprising one or more chairs; each chair (23) having a seat (72), a backrest (13) and a footrest (24), a motion platform (21) connected to the seat, at least one special effects cabinet (20) contained in the chair and a user console (34) configured to selectively communicate with one of the plurality of audiovisual sources, and including a controller (74) in communication with the motion platform (21), with the at least one special effects cabinet (20) and with the user console (34); wherein the user console (34) is configured to selectively communicate with one of the plurality of audiovisual sources (35, 36). The method comprises providing (200) a menu to a user to select (201) a mode from: a cinema mode, a gaming mode, a relaxing mode, and a simulator mode; and causing (204) the controller (74) to send a set of synchronized signals to the motion platform (21) and to the at least one special effects cabinet (20) in response to an input signal based on an audiovisual signal received (203) from the user console (34) and the selected mode; or in response to an input signal based on an audiovisual signal received (202) from the selected audiovisual source (35, 36) and the selected mode.

In some embodiments, in the cinema mode, each chair (23) moves its motion platform (21) and activates the one or more special effects cabinets (20) in synchronism with audiovisual content, according to a previously programmed and encoded sequence; in the gaming mode, each chair (23) communicates through different protocols with an external device selected from a group formed by, but not limited to: PCs, laptops, game consoles, smartphones, smartwatches, tablets and virtual reality headsets (36) and generates movements and special effects synchronized in real time with the action that takes place within the game; in the relaxing mode, each chair (23) changes the ergonomic position of its backrest (13) and footrest (24) and, triggered from an external device (36) or a mobile device (35), or through pre-programmed cycles, it generates movements, vibrations, lights and aromas in relaxation routines; and in the simulator mode, the user mounts a removable accessory/support (37) to the chair; wherein said accessory/support (37) allows mounting different peripherals and commercial game controls, selected from the group consisting of, but not limited to: steering wheels, pedals, gear shifters, airplane controls, joysticks and displays; and for allowing those said peripherals and game controls to accompany the movement of the chair in its motion, turning the chair into a simulator with movements and effects.

In some embodiments, the entertainment system is designed to be used in the household setting.

In some embodiments, the user selectively adjusts the position of the backrest (13) and the footrest (24).

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a front perspective view of the chair of the present disclosure;

FIG. 2 shows the available movements of the chair of the present disclosure;

FIG. 3 illustrates the components of the entertainment system of the method of the present disclosure in the cinema mode;

FIG. 4A shows the components in the method of the present disclosure in the gaming mode;

FIG. 4B shows the components in the method of the present disclosure in the simulator mode;

FIG. 5 shows a detail of the position of the chair in the method of the present disclosure in relaxing mode;

FIG. 6 shows the components in the method of the present disclosure in relaxing mode;

FIG. 7A shows the smoke effect generator in the environmental special effects box;

FIG. 7B shows the wind effect generator in the environmental special effects box;

FIG. 7C shows the water effect generator in the environmental special effects box;

FIG. 7D shows the lights effect generator in the environmental special effects box;

FIG. 7E shows the aroma effect generator in the environmental special effects box;

FIG. 8 shows a side view of the chair of the present disclosure;

FIG. 9 shows the special effects generator devices contained in the environmental special effects box;

FIG. 10 shows a side view of the chair with the integrated special effects cabinet of the present disclosure;

FIG. 11 shows the elements that generate the front Air Impact effect in the chair of the present disclosure;

FIG. 12 shows the elements that generate the left and right Air Impact effect in the chair of the present disclosure;

FIG. 13 shows the elements that generate the aroma effects in the chair of the present disclosure;

FIG. 14 shows the elements that generate the wind effect in the chair of the present disclosure;

FIG. 15 shows the elements that generate the light effect in the chair of the present disclosure;

FIG. 16 shows the elements that generate the water effect in the chair of the present disclosure;

FIG. 17 shows the elements that generate the smoke effect in the chair of the present disclosure;

FIGS. 18A and 18B show the removable accessory support for mounting game accessories on the chair of the present disclosure;

FIG. 19 shows the entertainment system configuration with a user console;

FIG. 20 shows the entertainment system configuration with a PC or a game console;

FIG. 21 shows the entertainment system configuration with a mobile device;

FIG. 22 shows the steps of the method of the present disclosure;

FIG. 23 shows in detail the steps of the cinema mode;

FIG. 24 shows in detail the steps of an embodiment of the gaming mode including two alternatives;

FIG. 25 shows in detail the steps of the relaxing mode;

FIG. 26 shows in detail the steps of the simulator mode;

FIG. 27 shows the block diagram of the user console; and

FIG. 28 shows the placement of the controller in the chair.

### DETAILED DESCRIPTION

This disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The present disclosure includes a multi-functional, integrated chair and controller entertainment system that expands the experiences of watching television (TV), playing video games, sharing videos, watching live events, or simply relaxing. In some embodiments, the system includes a chair that delivers movements of two or more degrees of freedom and special effects such as vibration, wind, aroma, air, lights, water, etc., to a variety of entertainment and relaxation experiences. In some embodiments, the chair contains all the effects and the systems used to generate these special effects such as an air compressor, a water container, light sources and aroma sources housed inside, simplifying its installation and turning it into a plug and play device. The chair is designed essentially for the home, it is synchronized with an audiovisual content and receives and runs commands to produce the effects. The chair of the present disclosure is also designed to operate in three different hardware configurations and comprises a method of using the entertainment system in at least four modes. “Cinema mode,” “Gaming mode,” “Relaxing mode,” and “Simulator mode” and also comprises an environment special effects box.

As used herein, “chair” may refer to anything a user may use to sit on or relax on. In some embodiments, a chair includes a seat surface and a back surface.

Description of components and accessories of the entertainment system:

The entertainment system of the present disclosure comprises, in a basic version, the following devices: i) one or more chairs and ii) a user console 34 commercially called 4Dtv acting as an interface.

In an alternative embodiment, the following components can be added: iii) a support 37 for simulator/game controllers, iv) one or more environmental special effects boxes 173 and the following interfaces: v) a cell phone 33 (See FIG. 3) in which an application software (APP) is loaded, vi) a personal computer (PC), a laptop or a notebook; vii) and a game console.

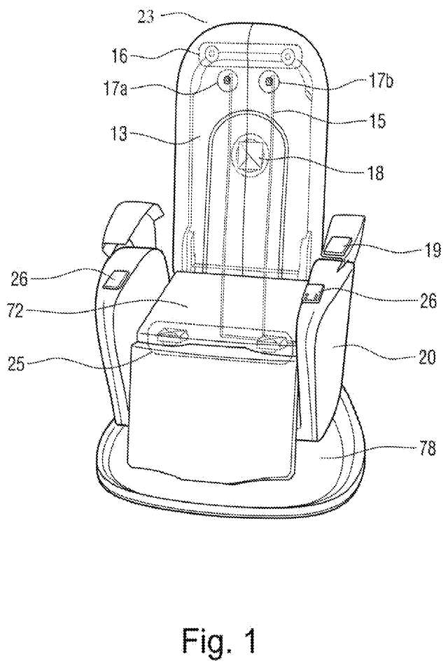

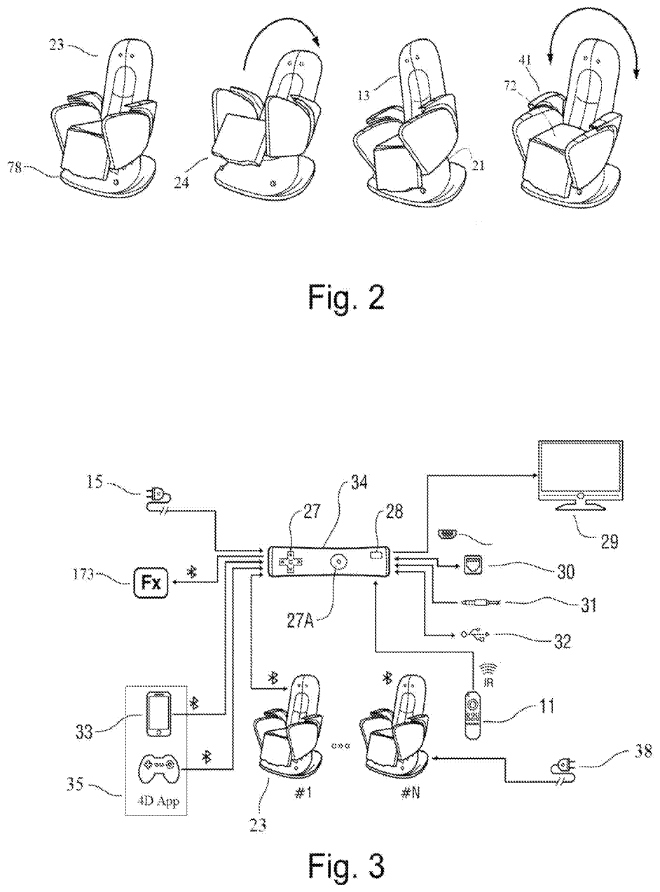

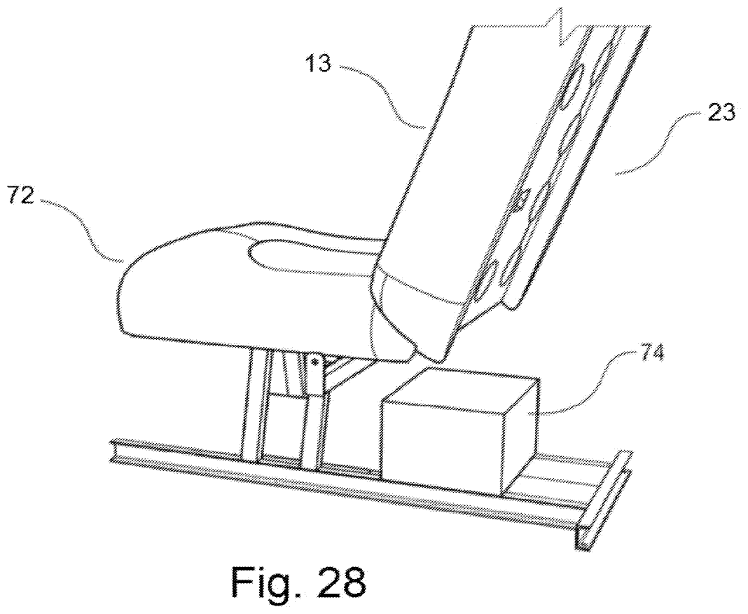

The chairs: FIGS. 1, 8, 12 and 28 show that each of the chairs comprise an electromechanical device physically comprising a seat 72 mounted on a motion platform 21, which in turn is mounted on a base 78. The platform 21 is equipped with a motion arrangement 44 that is able to tilt to the left and right directions, in the forward and back directions, and in their combinations. The chair 23 comprises a backrest 13, a seat 72, two armrests 41, at least one special effects cabinets 20, a footrest 24, an electric reclining system (see FIGS. 14A and 14B), an electronic controller unit 74 (See FIG. 28), and a socket 22 for mounting a removable accessory support 37 for the simulator mode. The base 78 has a supportive surface that provides stability to the chair 23 against the forces exerted by the motion platform 21 for its entire range of motion, preventing the chair 23 from tipping over, thereby freeing the chair 23 from the need of being anchored to the ground or fastened to any structure. This turns the chair into a very suitable device for being used in any user's home since it may be placed in any suitable room.

In some embodiments, the chair 23 comprises the following elements (See FIG. 1):
a. The backrest: the backrest 13 has inserted within it one or more vibration-generating devices (bass shakers) 18, which react to sound and vibration frequencies. It also has, at the height of the headrest, two air impact nozzles 17a, 17b through which pressurized air comes out in a programmed manner; and inserted in the foam, at the height of the headrest, it has two speakers 16 to output surround sound.
b. The seat: the seat 72 has inserted two or more vibration generator devices (bass shakers) 25, which react to sound and vibration frequencies in a programmed manner.
c. One or two special effects cabinets 20. Each special effects cabinet 20 includes all the components to generate the special effects integrated in a single unit. It requires a very simple setup, offering a solution known as “plug and play”, avoiding the use of peripheral devices, as well as cables, hoses and any other external connections (other than the usual AC power connection). In any of two preferred embodiments, the chair 23 might comprise one or two special effect cabinets 20 that are located under the armrests 41. The entertainment system required a carefully engineered design, since it integrates a set of effects with reasonable costs that will be used in a home environment with simple, fast and low-cost rechargeable supplies.
d. Electronic controller unit: The electronic controller unit 74 is in charge of handling the automation of the movements and the special effects of the chair 23. This electronic controller unit 74 houses a power supply, a printed circuit board containing one or more microprocessor, one or more random-access memory (RAM) and one or more electrically erasable read-only memory (EEROM) loaded with the automation software, the drivers for the actuators, and also houses the electronic boards to control the different components that generate the special effects and for handling the communication of the electronic controller unit 74 with external devices 34, 36.

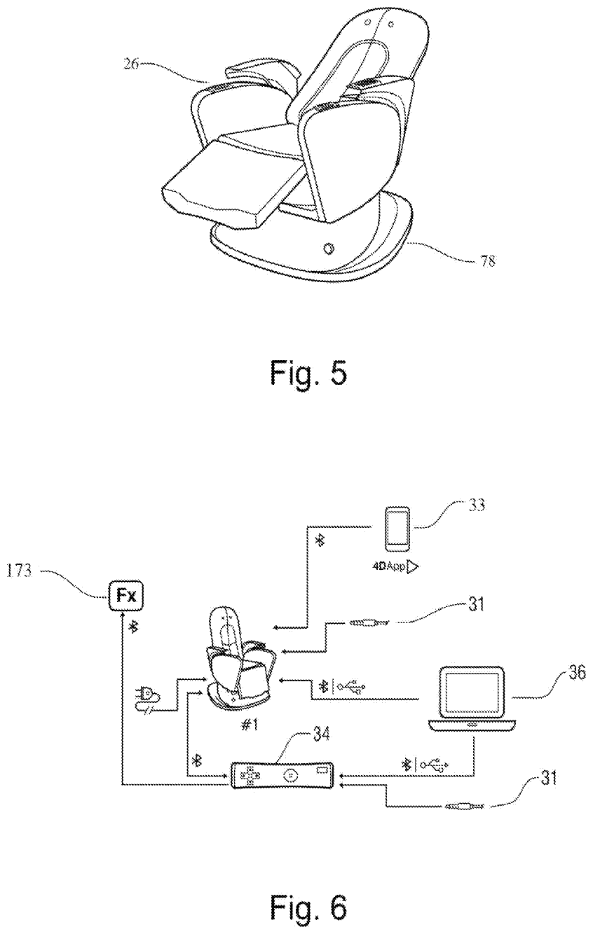

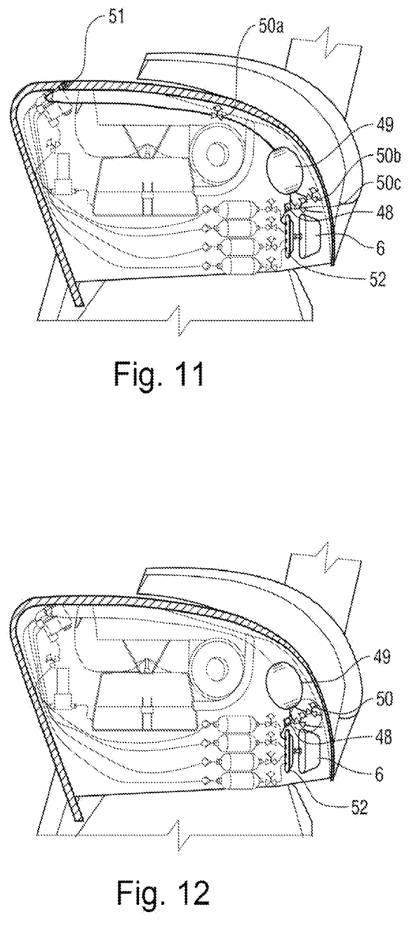

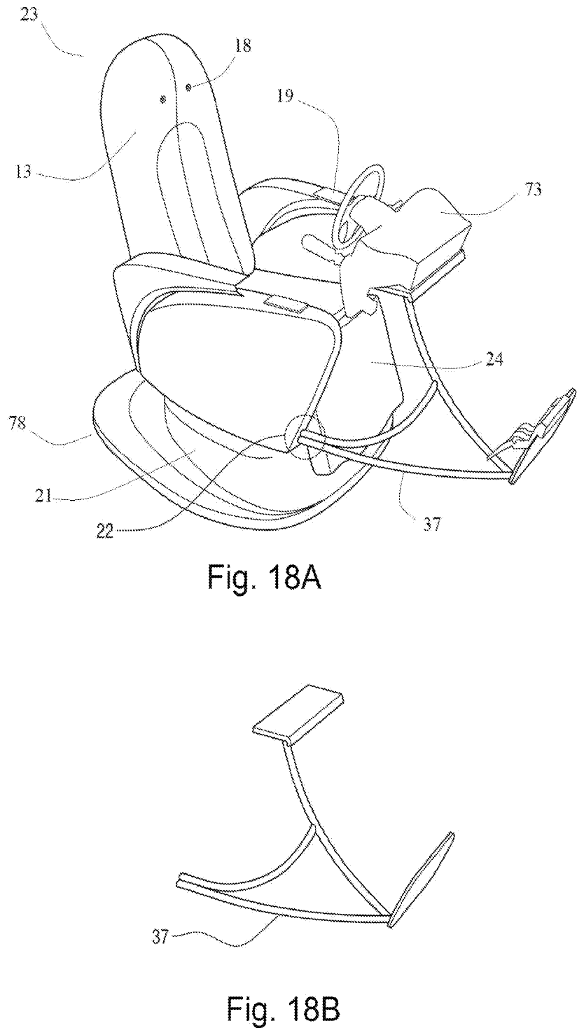

FIG. 11 shows the following elements that are contained within the at least one special effects cabinets 20: wind effect generator; smoke effect generator; aroma effect generator; water spray effect generator, air impact generator and light effect generator. Each of the effects generators will be explained in later paragraphs and may be seen in more detail in FIGS. 11-17.
d. Armrests (FIG. 1): At least one of the armrests 41 has a control panel 19 inserted therein, consisting of a touch screen, a keypad, potentiometers and switches to adjust the system configuration parameters.
e. The electric reclining system (FIGS. 14A and 14B): changes the position of the seat-backrest-footrest assembly from the initial position of the user sitting to the final position of the user laying down (FIG. 5).
f. Simulator anchor (gamer): (FIGS. 18A and 18B) It comprises an accessory/support socket 22 that allows for the mounting of a removable accessory support 37 for simulator and game controllers to mount different peripherals and commercial controls for software simulators and video games, selected from the group formed by, but not limited to: steering wheels, pedals, gear-shifters, airplane controls, joysticks and displays; and for allowing those peripherals and game controls to accompany the movement of the chair in its motion, turning the chair into a simulator with movements and effects.
g. Vibration effects (See FIG. 1): The vibration effect is generated by one or more vibration generator devices (bass shakers), wherein at least one of them 25 is inserted inside the seat foam and at least one 18 is inserted inside the backrest foam. Mode of operation: The vibration effect is pre-programmable and the following parameters can be adjusted, an ON-OFF command can be selected, it can respond to two types of signals: (i) the low frequencies of the audio of the film or (ii) pre-set programmable frequencies to generate different vibrations according to the amplitude and length of these waves. Both the audio frequency signals and the pre-programmed frequencies can operate individually or simultaneously. These options allow that, for example, in a movie scene the bass shakers do not vibrate during a certain moment, in another moment they vibrate together with the low frequencies that the user can listen in the TV or sound equipment, and also in another time, the bass shaker may vibrate due to added frequencies. For example, for a hit in a movie fight that should be highlighted, a frequency is previously generated and saved, making the bass shaker vibrate at that precise moment.

The motion platform 21, the backrest 13, the seat 72, the armrests 41, the special effects cabinet 20, the electronic controller unit 74 and the base 78 form an electrically and mechanically linked unit, therefore the one or more chairs are free from the need of being assembled by a user and free of the need of a special electrical or mechanical infrastructure for their operation, making the entertainment system suitable for its use at home.

Furthermore, the special effects cabinet 20 of the present disclosure contains all the technology to generate the effects and to deliver them to the user in a single housing.

In each special effects cabinet 20, there is an outlet 26 (see FIGS. 1 and 11) comprising: a) an air outlet port 2 for wind and smoke effect; b) an aroma outlet nozzle 10; c) a water outlet nozzle 5; and d) a front air impact outlet nozzle 51.

### Description of the Effects Generators

A detailed description of each of the effects generators contained in the one or more special effects cabinet 20 will now be outlined.

i) FIG. 14 shows the wind effect generator. It comprises an air intake 12, located on the wall of the special effects cabinet 20, a low-density air filter (not shown), a silent low flow axial turbine blower 1, a plastic main conduit 53, and air outlet port 2.

Mode of operation of the wind effect generator: a signal activates the axial turbine blower 1 which draws the air from the air intake 12 passing through the air filter into a plastic main conduit 53, which conducts the air towards the air outlet port 2 of the special effects cabinet 20 pointing to the user's face. The turbine blower 1 has a programmable “on” and “off” command and a blowing power control, being able to generate from soft breeze to an intense wind at any desired moment. It is a low maintenance device.

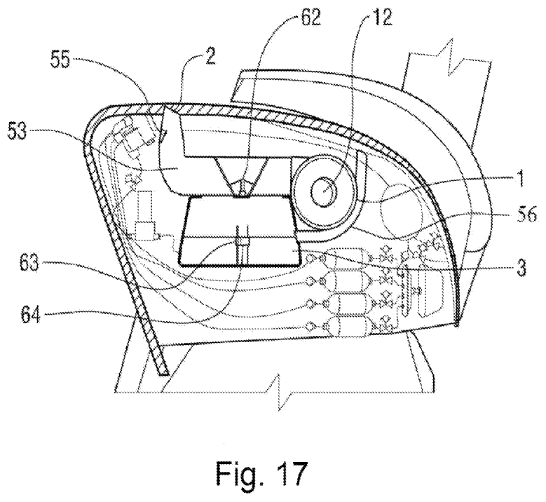

ii) FIG. 17 shows the smoke effect generator. It comprises a water tank 3 with a water-charging tube 56, a conduit 53 with automated dampers 62 and an air outlet port 2. Inside the water tank 3a small ultrasonic transducer 63 is inserted inside a floating device 64. This ultrasonic transducer 63 vibrates at an ultrasonic frequency breaking the water particles in the water tank 3 generating mist (the same operation of an ultrasonic nebulizer) to simulate smoke and also, at one end of the plastic main conduit 53, a small red/green/blue (RGB) light-emitting diode (LED) 55 is mounted.

Mode of operation of the smoke effect generator: (a) the signal that feeds the ultrasonic transducer 63 is activated and begins to break up the water particles generating mist that accumulates in the free space of the water tank 3. (b) After a period of about 15 seconds a second signal opens the tank inlet and the outlet dampers 62, both dampers being connected to the plastic main conduit 53. (c) The turbine blower 1 is activated, pushing the mist that simulates smoke from the water tank 3 towards the plastic main conduit 53, and from there to the air outlet port 2 of the special effects cabinet 20, which aims toward the user's face. (d) As soon as the mist comes out, the RGB LEDs 55 may be activated, to illuminate and dye the mist in several colors. The smoke effect generator generates mist instead of smoke to ensure the safety of the user's breathing health.

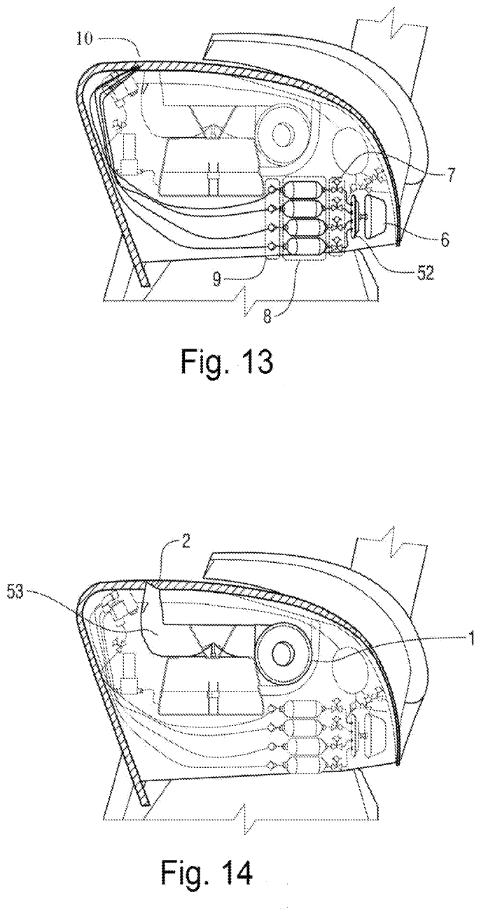

iii) FIG. 13 shows the aroma effect generator: It consists of extractable containers 8 that hold aromas or scent fluids, and a low-flow air compressor 6 as well as four air solenoid valves 7. The outlet of the air compressor 6 is connected to an air divider 52 by polyurethane hoses that distribute the air to the four air solenoid valves 7. Each air solenoid valve 7 is connected to a cartridge or aroma container 8. A second flexible polyurethane tube 14 (See FIG. 11) is connected to the air outlet of each aroma container 8 through a check valve 9 and connects to one of the four aroma outlet nozzles 10 located inside the air outlet port 2.

Mode of operation of the aroma effect generator: the signal that turns on the air compressor 6 is activated and one of the four air solenoid valves 7 is enabled, pushing the air through the polyurethane tube to one of the aroma containers 8 where the air passes through the solid state aroma product. After being impregnated with the aroma, the air exits through the polyurethane tube 14 connected to the outlet that conducts the air to one of the aroma outlet nozzles 10 connected inside the air outlet port 2 of the special effects cabinet 20. At that moment, the turbine blower 1 is activated, pushing the air impregnated with aroma to the user's face. Each aroma has its individual outlet nozzle 10, therefore, the aromas are never mixed, avoiding cross smell contamination. The aroma cartridges 8 have a set of identifying rings that fulfill two functions: on one hand they make sure that each cartridge is mounted in a unique position and on the other hand they allow a user to distinguish between three different cartridge models, which allows changing to different aromas for different experiences.

iv) FIG. 16 shows the water spray effect generator: it comprises the water tank 3 connected to an inner polyurethane tube connected to the inlet of a pressurizing water pump 4, a second polyurethane tube 60 connected to the outlet of the water pump 4 and to the inlet of a normally closed water solenoid valve 57 which has at its outlet a nozzle 5. The water tank 3 is also connected to a water-charging tube 56 for manual refill.

Mode of operation of the water spray effect generator: a signal activates the water pump 4 which pressurizes the outlet tube 60 towards a water solenoid valve 57. A second signal opens the water solenoid valve 57 for a fraction of a second that lets the water pass-through the water outlet nozzle 5, generating a water spray towards the user's face.

v) FIGS. 11 and 12 show the air impact generator, which comprises an air compressor 6 connected to an air divider 52 with a polyurethane tube, and connected to the inlet of an air container 49 through an air check valve 48. The air container 49 has three outlets, each one connected to the inlet of three air solenoid valves 50a, 50b, 50c and the outlet of the valve 50a is connected to the front air impact outlet nozzle 51 to generate a front air impact effect. The outlet of the air solenoid valve 50b is connected to the right air impact nozzle 17a to generate the right side neck air impact effect and the outlet of the air solenoid valve 50c is connected to the left air impact nozzle 17b to generate the left side neck air impact effect.

Mode of operation of the air impact generator: The air compressor 6 sends the air through the air check valve 48 to the air container 49 to maintain a pressure of around 4 10⁵ Pa (4 bar) constantly in it. In order to generate the front air impact conducted through the polyurethane tube to the front air impact outlet nozzle 51, effect, a signal activates the air solenoid valve 50a, releasing pressurized air that is generating an air current on the user's face. For generating the right side neck air impact effect, a signal activates the air solenoid valve 50b, releasing pressurized air that is conducted through the polyurethane tube to the right side air impact nozzle 17a, generating an air impact on the user's right part of the neck; and for generating the left side neck air impact effect, a signal activates the air solenoid valve 50c, releasing pressurized air that is conducted through the polyurethane tube to the left side air impact nozzle 17b, thus generating an air impact on the user's left part of the neck.

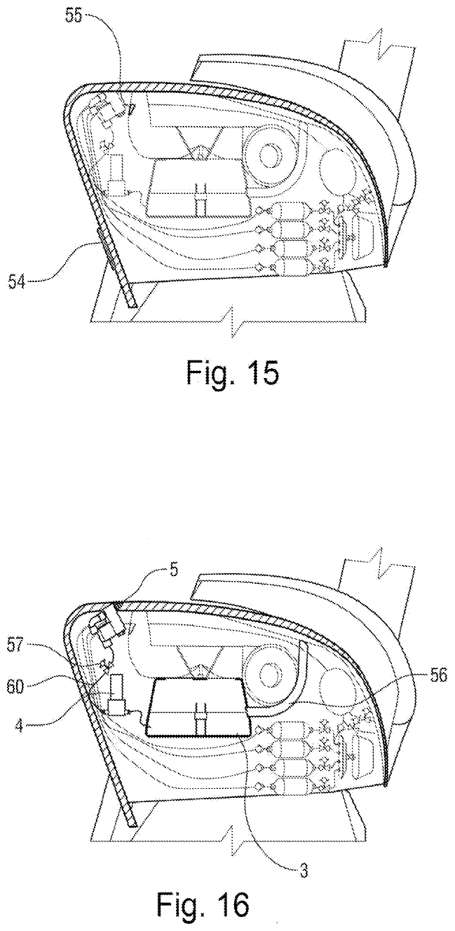

vi) FIG. 15 shows the light effect generator: This effect generator is comprised by a RGB LED light source 54 located at the base of the special effects cabinet 20 and a lower power RGB LED light source 55 located at the end of the plastic main conduit 53.

Mode of operation of the light effect generator: Both light sources are pre-programmable in color, intensity and duration and can be synchronized with the images of a video or a game. The light source 54 is used to illuminate and give color to the area and the objects around the chair 23. The light source 55 is used in combination with the smoke effect to illuminate and dye the mist with different colors.

As already mentioned above, FIG. 10 shows a full set of special effects generators in the special effects cabinet 20. However, in a first embodiment, a basic chair 23 may comprise a single special effects cabinet 20 containing only a basic effect set comprising the following effects; aroma effects; water spray effects, light effect and wind effect.

In another embodiment, the chair 23 may comprise a single special effects cabinet 20 containing the basic effect set plus a smoke effect generator.

In a further embodiment the chair 23 may comprise a single special effects cabinet 20 containing the basic effect set plus an air impact effect generator.

In a further embodiment the chair may comprise a single special effects cabinet 20 containing the basic effects set, a smoke effect generator and an air impact effect generator.

In a further embodiment the chair 23 may comprise two special effects cabinets 20, each containing one of the effects combinations described above.

### Chair Hardware Configurations:

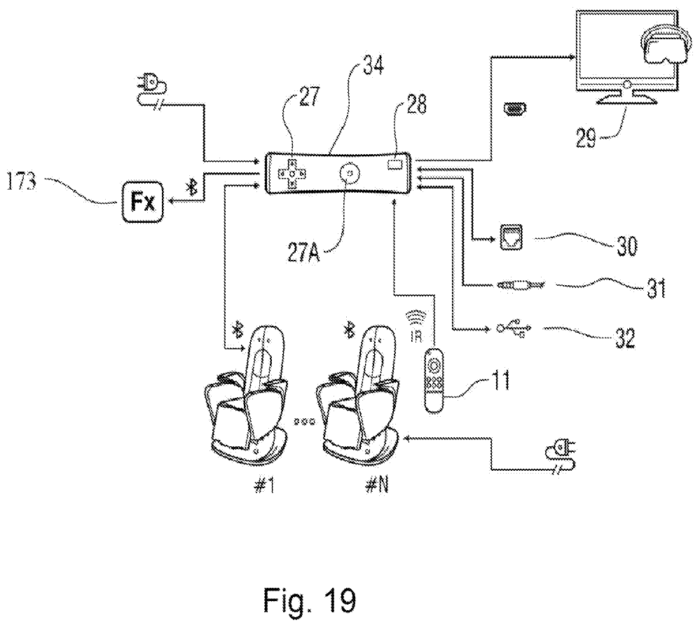

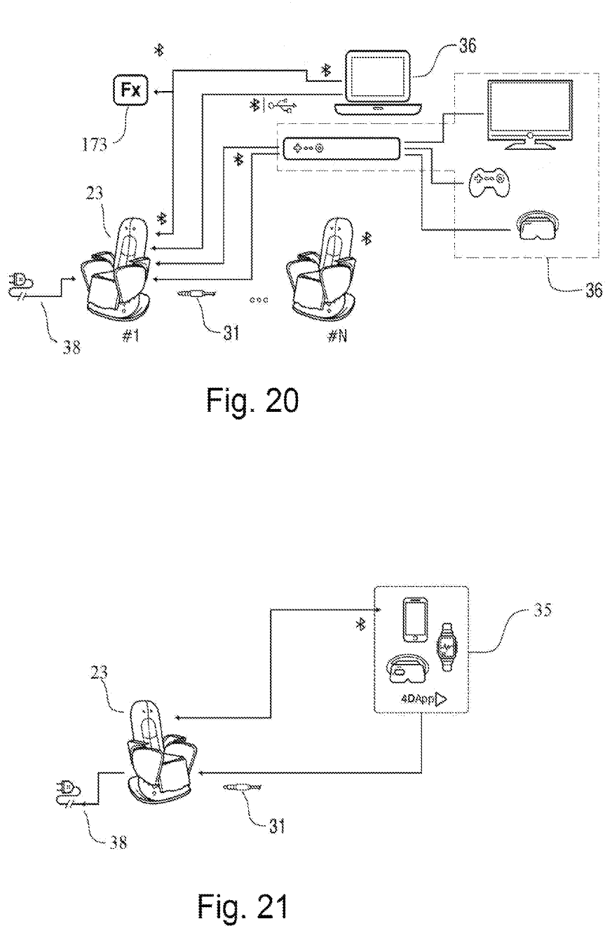

Each chair 23 is designed to operate in three different hardware configurations: (i) configuration with a user console 34 (FIG. 19); (ii) wired configuration with a PC, laptops, a game console, tablets and virtual reality headsets 36 (FIG. 20); (iv) wireless configuration with a mobile device such as smartphone and smartwatches, tablets and virtual reality headsets 35 (FIG. 21).

(i) FIG. 19 shows that the hardware configuration with a user console 34 includes at least one chair 23 connected to a user console 34; and comprises communication with a display device 29 selected from the group consisting of, but not limited to: TV, smart TV, monitor, video projector or VR headset.

### The User Console 34 (FIG. 3):

The user console 34 is a central console interface which allows selecting audiovisual content to be played back and obtains the corresponding synchronization files from a 4D server provided by the inventor. The term 4D is a term for an entertainment presentation system combining a 3D audiovisual contents with physical effects that occur in synchronization with the contents. The user console 34 is able to analyze the selected audiovisual content, select the sync file and synchronize the at least one chair 23 with the audiovisual content. The user console 34 can communicate with devices such as: one or more chairs, simultaneously, one or more environmental special effects boxes 173 simultaneously and with external wired and wireless devices such as PCs, laptops, game consoles, smartphones, smartwatches, tablets and virtual reality headsets 35, 36. The user console 34 is able to store and play back audio and video content, execute video game software and store pre-programmed cycles to produce movements and to trigger special effects for the one or more chairs and for the one or more environmental special effects boxes 173. The user console 34 can communicate through an internet connection with digital platforms (not shown) of audio and video content.

The functions of the user console 34 will now be listed:
a. Synchronization management, which comprises synchronization of the audiovisual content with the one or more chairs and/or the one or more environmental special effects boxes 173.
b. Device management (devices that can be connected to the console: chairs 23, environmental effect boxes 173, TVs, smartphones, external disks, etc.), and local storage of user information profiles and settings.
c. Communication management with a central server controller for upgrades and obtain synchronization files.
d. Communication management with digital content platforms and local content management

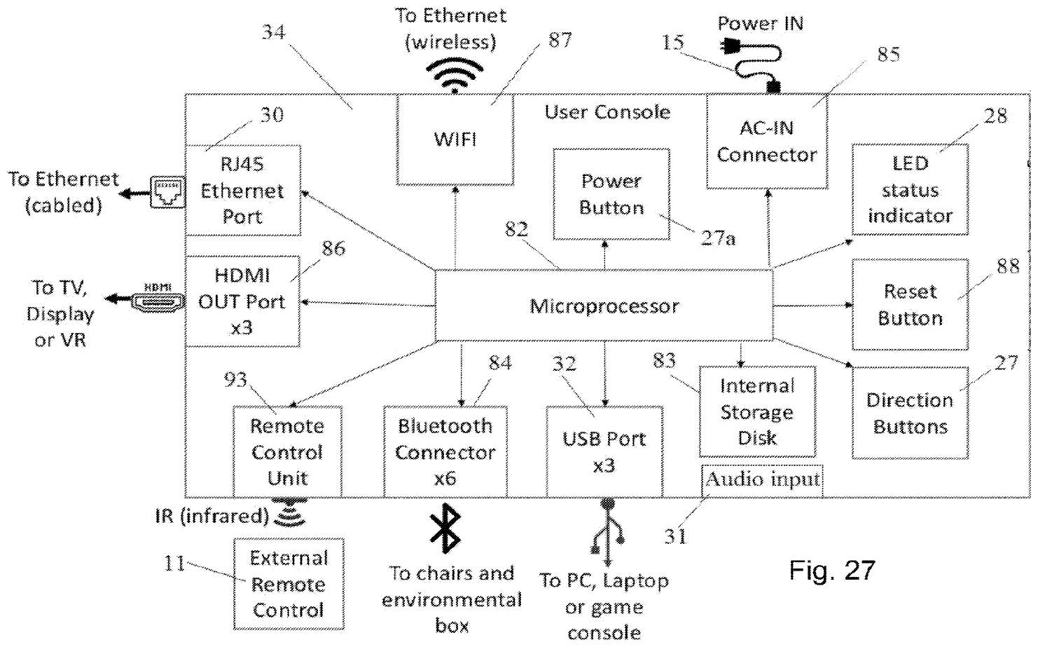

The main components of the user console 34 shown in FIG. 27 are: (i) a microprocessor 82, (ii) an internal storage disk 83, (iii) Bluetooth connectors 84 (up to 6), (iv) AC-IN connector 85, (v) 3 high-definition multimedia interface (HDMI) OUT ports 86, (vi) RJ45 port 30 (optional use) or Wifi wireless connection 87, (vii) 3 USB ports 32 to connect external devices (e.g. external disk), (viii) power button 27a, (ix) reset button 88 to reset to factory settings and (x) LED status indicator 28 of the console. The LED colors showing: color-1: console on; color-2 or color-1 flashing while powering up; color-3: console idle; (xi) direction buttons 27 (arrows up, down, right, left): to navigate in the application, in case the remote control 11 is not working; (xii) “OK” button 89 (center between the arrows): allows you to confirm the selected item in the application; (xiii) remote control 11. (ix) The console power button 27a: it allows to turn on the system (when the system is off or in standby mode), it also displays the home screen (when the system is on) or turn off the system (when the system is on and is pressed for more than 2 seconds); (x) 4D button 90: it tries to locate the synchronization for the content seen/heard on the screen/Enable/Disable 4D; (xi) back button 91: it allows to cancel a command and returning to the previous screen; (xii) MENU button 92: it displays the MENU; (xiii) Remote control unit 93; (xiv) AC power cable 15.

The user console 34 has a power on/off button 27a and a signaling LED status indicator 28, and can control, through the HDMI output ports 86, external displays 29 such as TVs, Smart TVs, monitors, projector, VR headset, etc. The user console 34 can have access to a central server or to digital platforms (not shown) of audiovisual content and to other remote devices via the internet. It can also receive audio through an audio input 31 provided for such purposes or it can connect to a storage device or an external devices such as PCs, laptops, game consoles, tablets and virtual reality headsets 36 via a USB port 32 or via wireless networking (WiFi) 87 with mobile devices such as smartphones or smartwatches, tablets or virtual reality headsets 35. It can also connect to a remote control 11, via infrared light. Using the direction buttons 27 of the user console 34, or the remote control 11, the user navigates through the menus of the user console, selecting the audiovisual content and configuring the entertainment system. The user console 34 is capable of creating and editing movement schedules and to create and edit timing sequences of special effects, trigger commands for the one or more chairs, and allows the entertainment system to share these schedules and sequences with other identical entertainment systems in other locations, via the internet or mobile phone communications.

The user console 34 allows the user to command more than one chair 23 at a time from a single audiovisual source. If no user console 34 is used, the command from an external device 35, 36 can only handle one chair 23 at a time.
(ii) FIG. 20 shows the wired hardware configuration with a PC, laptops, notebooks, tablets or a game console, and virtual reality headsets 36.
(iii) FIG. 21 shows the wireless hardware configuration with a mobile device, in which the one or more chairs are connected directly to a mobile device selected from the group consisting of, but not limited to: smartphones, smartwatches, tablets and virtual reality headsets 36.

The entertainment system of the present disclosure is supplemented by the following optional components:

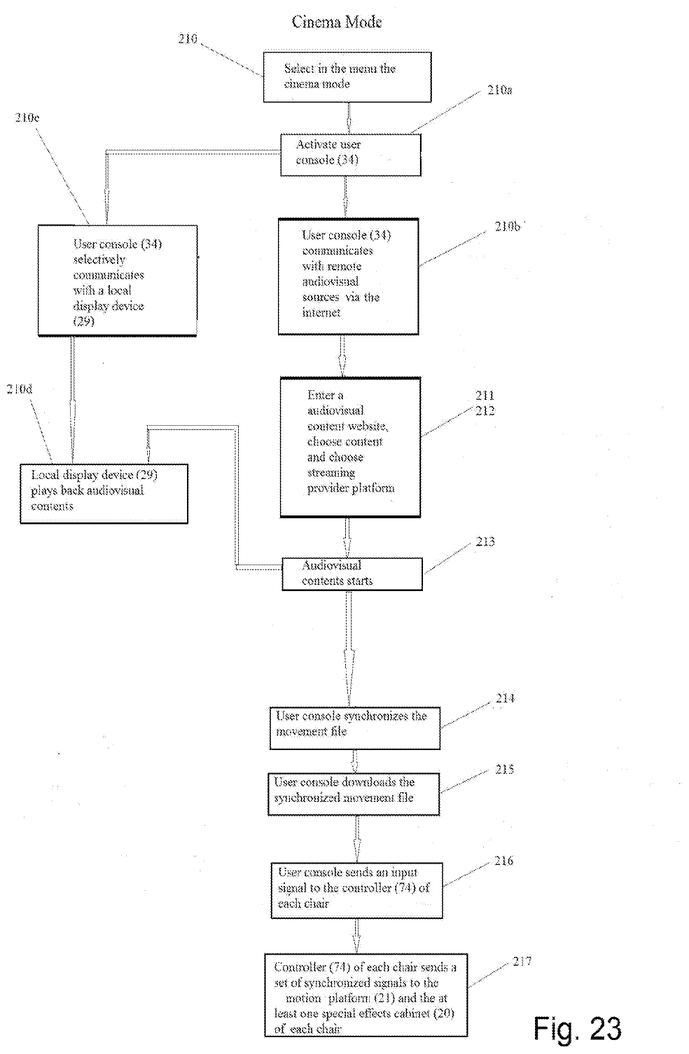

Removable accessory support 37 for simulator/game controllers: FIGS. 23A and 23B show that the simulator/gamer controller support 37 is a removable mechanical accessory for mounting controller simulators and commercial games 73, such as car steering wheels, pedals, airplane controls, displays etc. It turns the chair into a ship or vehicle simulator, with the “on board” commands, that is, they move with the user. The chair 23 comprises a fixed socket 22 for mounting the removable accessory support 37.

Application software (APP). This is a software application (APP) that allows the user to control the chair to provide different types of experiences or interface with other applications such as games, relaxation, remote control for user console 34, etc. The APP is a software that, through its user interface (UI), allows user interaction with all the functionality provided by the system. The APP software is hosted in any of the following interfaces: i) the user console 34; ii) a mobile phone 33 (See FIG. 3) or iii) a PC, a laptop, a notebook. The APP interface can be viewed on any device, tablet, TV, laptop. Through the APP the user can send commands that the user console 34 executes and manages. A gamer controller acting as an interface cannot host the APP and requires a specially developed driver.

Examples of APP functions: To send commands such as turning the console on or off; allow immediate access to the content platform: search for content; send commands to execute functions and programs in each of the usage modes: Cinema, Games, Relax and Simulator (that will be described in the paragraphs related to the method of the disclosure); it allows configurations of Bluetooth devices; chairs, environmental effects; it allows the user to view the status of consumables supplies for the special effects; it allows to store the user activities; and it allows to create and store user profiles.

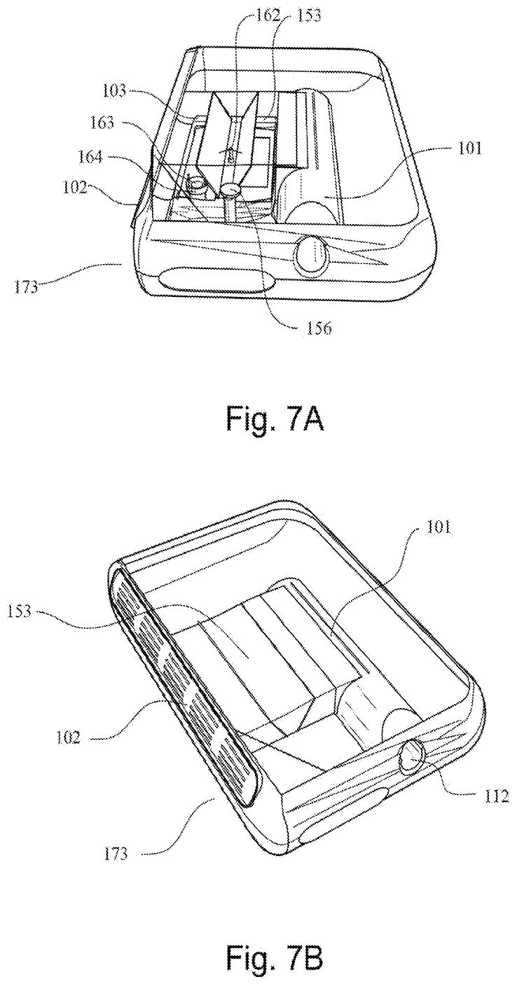

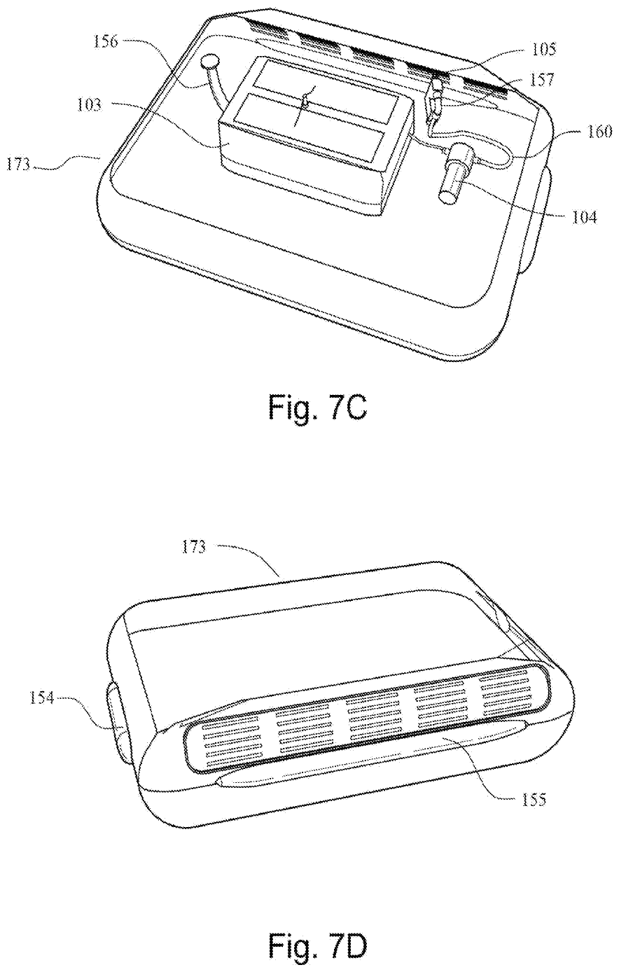

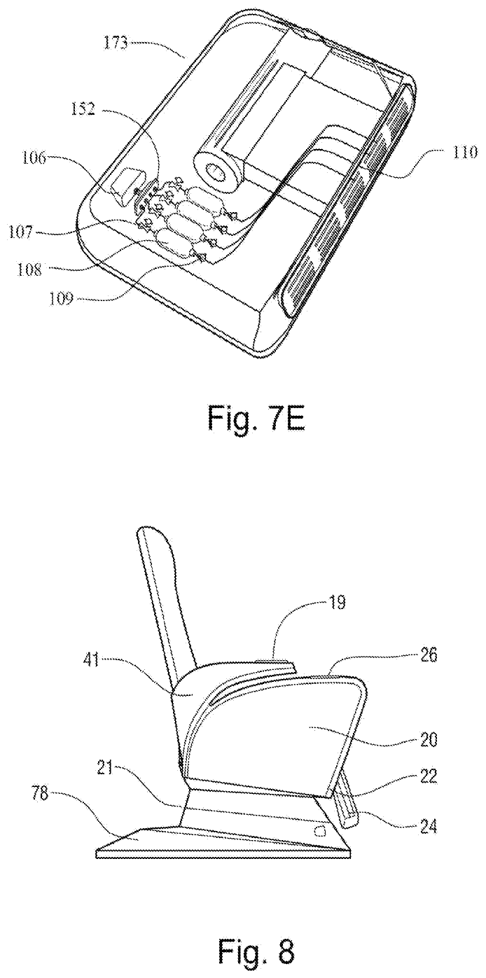

### Environmental Special Effects Boxes (FIGS. 7A, 7B, 7C, 7D, 7E and 10)

The environmental special effects boxes 173 are also an important object of the present disclosure. One or more environmental special effects boxes 173 may be used in the entertainment system. They receive the signal and play-back special effects in a similar way as a chair, but are distributed in the environment. In order to achieve this, each special effects box 173 contains a controller unit 111 in the same way as the electronic controller 74 contained in each chair. The one or more boxes generate environmental special effects 173 and contain one or more environmental special effects generator devices. The environmental special effects are generated in synchronism with an audio or video signal. The controller unit 111 of the environmental special effects boxes 173 receive the commands to generate the environmental special effects from the user console 34 or from at least one external device selected from the group formed by, but not limited to: PCs, laptops, game consoles, smartphones, smartwatches, tablets and virtual reality headsets 35. Each environmental special effects box 173 includes all the components to generate the special effects integrated in a single unit. It requires a very simple setup, offering a solution known as “plug and play”, avoiding to have peripheral devices for its operation as well as cables, hoses and any other external connections (other than the usual AC power connection). The present disclosure provides a carefully engineering design, since it has sought an integration of effects with reasonable costs that will be used in an environment of home use with a simple, fast and low-cost rechargeable supplies.

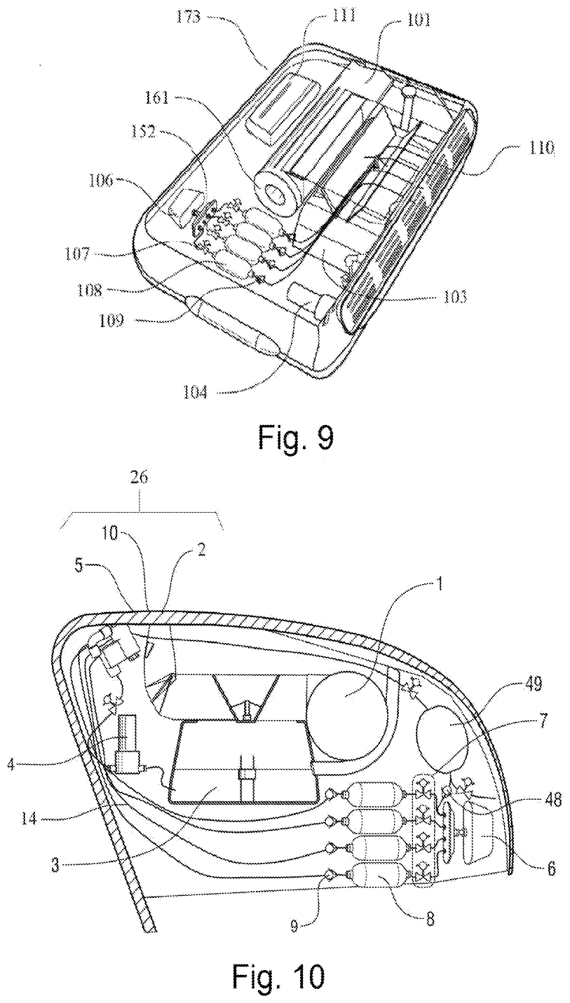

FIG. 9 shows the environmental effects generators of the environmental special effects boxes 173: environmental wind effect generator; environmental smoke effect generator; environmental aroma effect generator; environmental water spray effect generator, and environmental light effect generator and the electronic controller 111.

In each environmental special effects box 173 there is also an effects outlet (see FIG. 7B) comprising: the air outlet port 102 for wind and smoke effects; the aroma outlet nozzle 110 and the water outlet nozzle 105.

A detailed description of each of the environmental effects generators contained in each of the environmental special effects boxes 173 will now be explained.

FIG. 7B shows the environmental wind effect generator. It comprises an air intake 112, located on the side of environmental special effects box 173, a low-density air filter (not shown), the silent low flow axial turbine blower 101, a plastic main conduit 153, and the air outlet port 102.

Mode of operation of the wind effect generator: a signal activates the axial turbine blower 101 which draws the air from the air intake 112 passing through the air filter into a plastic main conduit 153, which conducts the air towards the air outlet port 102 and releasing the air to the environment. The turbine blower 101 has a programmable on and off command and a blowing power control, being able to generate from soft breeze to an intense wind at any desired moment. It is a low maintenance device.

FIG. 7A shows the environmental smoke effect generator. It comprises a water tank 103 with a water-charging the plastic main conduit 153 with automated dampers 162 and an air outlet port 102. Inside the tank 103 an ultrasonic transducer 163 is inserted into a floating device 164. This ultrasonic transducer 163 vibrates at an ultrasonic frequency breaking the water particles in the water tank 103 generating mist (the same operation of an ultrasonic nebulizer) to simulate smoke and also, at one end of the plastic main conduit 153, an RGB LED 155 is mounted.

Mode of operation of the environmental smoke effect generator: (i) the signal that feeds the ultrasonic transducer 163 is activated and begins to break up the water particles generating mist that accumulates in the free space of the water tank 103. (ii) After a period of about 15 seconds a second signal opens the tank inlet and outlet automated dampers 162, both dampers are connected to the plastic main conduit 153. (iii) The turbine blower 101 is activated, pushing the mist simulating smoke from the water tank 103 towards the plastic main conduit 153 and from there to the air outlet port 102 of the environmental special effects box 173, (iv) As soon as the mist comes out, the RGB LEDs 155 may be activated, to illuminate and dye the mist in different colors. The effect generates mist instead of smoke to ensure the safety of the user's respiratory health.

FIG. 7E shows the environmental aroma effect generator: It consists of extractable containers or cartridges that hold aromas 108, and a low-flow air compressor 106 as well as air solenoid valves 107. The outlet of the air compressor 106 is connected to an air divider 152 by polyurethane hoses that distribute the air to the four air solenoid valves 107. Each air solenoid valve 107 is connected to a cartridge or aroma container 108. A second flexible polyurethane tube is connected to the air outlet of each aroma container 108 which passes through a check valve 109 and connects to one of the four aroma outlet nozzles 110 located inside the air outlet port 102.

Mode of operation of the environmental aroma effect generator: the signal that turns on the air compressor 106 is activated and one of the four air solenoid valves 107 is enabled, pushing the air through the polyurethane tube to one of the aroma containers 108 where the air passes through the solid state aroma product. After being impregnated with the aroma, the air exits through the polyurethane tube connected to the outlet that conducts the air to one of the aroma outlet nozzles 110 connected just inside the air outlet port 102 environmental special effects box 173. At that moment, the turbine blower 101 is activated, pushing the air impregnated with aroma to the environment. Each aroma has its individual outlet nozzle 110, therefore the aromas are never mixed, avoiding cross contamination. The aroma cartridges 108 have a set of identifying rings that fulfill two functions: on one hand they make sure that each cartridge is mounted in a unique position and on the other hand they allow to distinguish between different cartridge models, which allows changing to different aromas for different experiences.

FIG. 7C shows the environmental water spray effect generator. It consists of the water tank 103 connected to an inner polyurethane tube connected to the inlet of a pressurizing water pump 104, a second polyurethane outlet tube 160 connected to the outlet of the water pump 104 and to the inlet of a normally closed water solenoid valve 157 which has at its outlet a water outlet nozzle 105. The water tank 103 is also connected to a water-charging tube 156 for manual refill.

Mode of operation of the environmental water spray effect generator: a signal activates the water pump 104 which pressurizes the outlet tube 160 towards a water solenoid valve 157. A second signal opens the water solenoid valve 157 for a fraction of a second that lets the water pass through the water outlet nozzle 105, generating a water spray towards the user's face.

FIG. 7D shows the environmental light effect generator. This effect is comprised by a RGB LED light source 154 located at the side of the environmental special effects box 173 and a lower power RGB LED light source 155 located at the end of the plastic main conduit 153.

Mode of operation of the environmental light effect generator: both light sources are pre-programmable in color, intensity and duration, and can be synchronized with the images of a video or a game. The light source 154 is used to illuminate and provide color to the area and the objects around the environmental special effects box 173. The light source 155 is used in combination with the smoke effect to illuminate and dye the mist in different colors.

The controller (111) is configured to receive an input signal based on an audiovisual signal from the selected audiovisual source (35, 36) and to send a set of synchronized signals to the special effects generators in the environmental effects box (173) in response to the received audiovisual signal.

In some embodiments, the controller 111 is configured to send the set of synchronized signals as a voltage. In some embodiments, the controller 111 outputs the voltage based on the input. In a basic embodiment, the set of environmental special effect generators contained in each of the one or more environmental special effects boxes 173 comprises a basic set formed by: an environmental smoke effect generator, an environmental light effect generator and an environmental wind effect generator.

In a more complete embodiment the set of environmental special effect generators further comprises the basic set and an environmental aroma effect generator.

In a still further complete embodiment, the set of environmental special effect generators further comprises the basic set, plus an environmental water spray effect generator.

In a still further complete embodiment, the set of environmental special effect generators further comprises the basic set, plus an environmental aroma effect generator and a water spray effect generator.

### Methods of the Present Disclosure

The method of the present disclosure is carried out by means of the entertainment system of the present disclosure comprised by one or more chairs and a user console 34 that integrates different independent functions. The method comprises providing a menu to the user to select one of the following four modes of operating the system: 1) Cinema mode; 2) Gaming mode; 3) Relax mode; and 4) Simulator mode.

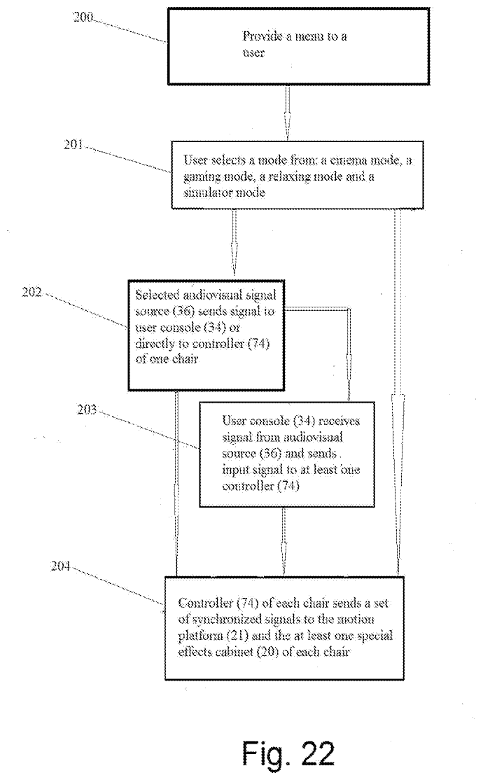

FIG. 22 shows in detail that the steps of the method comprises: providing 200 a menu to a user to select 201 a mode from: a cinema mode, a gaming mode, a relaxing mode, and a simulator mode; and causing 204 the controller 74 to send a set of synchronized signals to the motion platform 21 and to the at least one special effects cabinet 20 in response to an input signal based on an audiovisual signal received 203 from the user console 34 and the selected mode; or in response to an input signal based on an audiovisual signal received 202 from the selected audiovisual source 35, 36 and the selected mode. In some embodiments, the controller 74 is configured to send the set of synchronized signals as a voltage. In some embodiments, the controller 74 outputs the voltage based on the input.

Each mode of the method will be described in detail below:

### 1. Cinema Mode (FIG. 3)

The chair 23 provides a comprehensive experience for the user through motion and special effects synchronized with audiovisual content. One or more chairs are connected via a wireless link to the user console 34, which is in this mode the device that synchronizes the audiovisual content with one or more chairs simultaneously, based on pre-programmed, pre-recorded or live broadcast motion and special effects files.

In the cinema mode, the user console 34 analyzes the selected audiovisual content, selects the sync file and synchronizes the at least one chair 23 with the audiovisual content. The user console 34 communicates with devices such as: one or more chairs simultaneously, one or more environmental special effects boxes 173 simultaneously and with external devices such as PCs, laptops, game consoles, tablets and virtual reality headsets 36 or mobile devices such as smartphones and smartwatches 35. In this mode, the user console 34 stores and plays back audio and video content, executes video game software and stores pre-programmed cycles to produce movements and to trigger special effects for the one or more chairs and for the one or more environmental special effects boxes 173. In this mode, the user console 34 communicates through an internet connection with digital platforms (not shown) of audio and video content.

In this mode a plurality of chairs can receive simultaneously a synchronization signal from the user console 34 or individually from an external device 35, 36 to generate movements and special effects in the chairs.

Operation of the Cinema mode: The user enters the website where the available 4D synchronized audiovisual content is listed. He chooses the audiovisual content the wants to play and selects the streaming provider platform. The audiovisual content starts and the user console 34, analyzes the audiovisual content and determines the exact moment where the audiovisual content production is being played-back. Then, the user console 34 downloads the movement file previously synchronized and while playing-back the audiovisual content, the user console 34 sends the commands to move the chair and to deliver the special effects to the user accordingly.

In the cinema mode, each chair moves its motion platform 21 and activates one or more special effects generators in synchronism with the audiovisual content, according to a previously programmed and encoded sequence.

FIG. 23 shows in detail that the cinema mode comprises in a first embodiment the following steps:
(i) selecting 210 in the menu the cinema mode;
(ii) activating 210a the user console 34;
(iii) communicating 210b the user console 34 with remote visual sources via the internet;
(iv) entering 211 a website where the available synchronized audiovisual content is listed;
((v) choosing 212 an audiovisual content and selecting a streaming provider platform;
(vi) after the audiovisual contents starts 213, synchronizing 214 a movement file, and playing back 201d local display device 29 audiovisual content;
(vii) downloading 215 by means of the user console 34 the movement file previously synchronized; and
(viii) sending 216 while playing-back the audio visual content, by means of user console 34, said input signal to the controller 74 of each of the at least one chair 23.
(ix) sending the controller 74 of each chair a set of synchronized signals to the motion platform 21 and to the at least one special effects cabinet 20 of each chair

In a second embodiment, the cinema mode comprises the following steps:
(i) selecting 210 in the menu the cinema mode;
(ii) activating 210a the user console 34;
(iii) selectively communicating 210c the user console 34 with a local display device 29;
(iv) playing back 201d local display device 29 audiovisual content

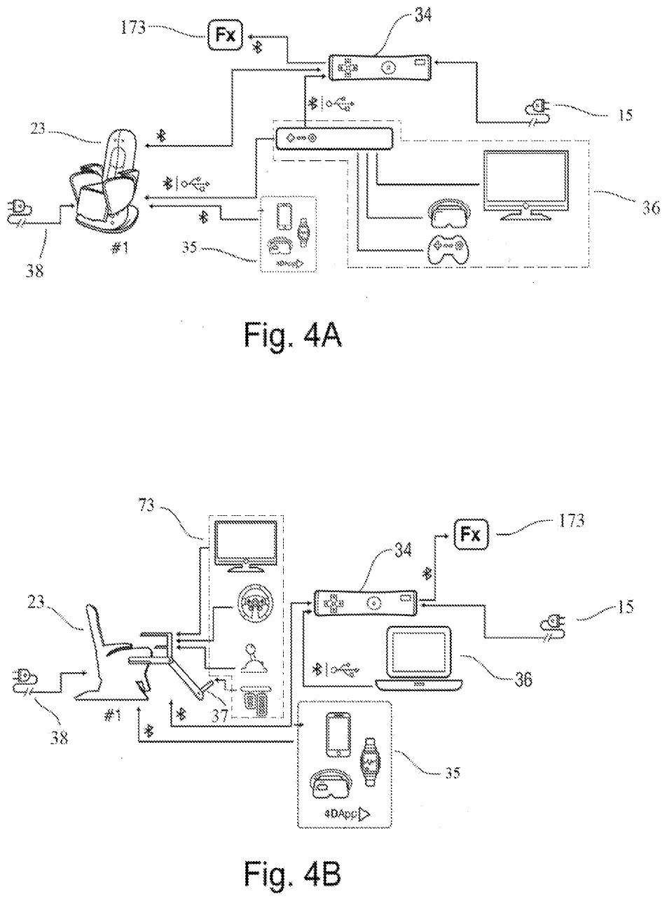

### 2. Gaming Mode (FIG. 4A)

In the gaming mode, each chair 23 may communicate through different protocols with external devices such as game consoles, PCs, cell phones, tablets or standalone virtual reality headsets 36, or mobile devices such as smartphones or smartwatches 35, and generate movements and special effects synchronized in real time with the action that takes place within the game. In the gaming mode the communication of the game consoles PCs, cell phones, standalone virtual reality headset or tablets 36 can be done directly to the controller 74 of each chair. The communication and synchronization of these devices with the internal controller 74 of the chair requires the use of software drivers that provide the required protocols for establishing the connection. However, if the audiovisual source of the external device is to be shared among more than one chair, the external devices are connected to the user console 34 which is in charge of communicating the audiovisual contents to the controller 74 of each chair.

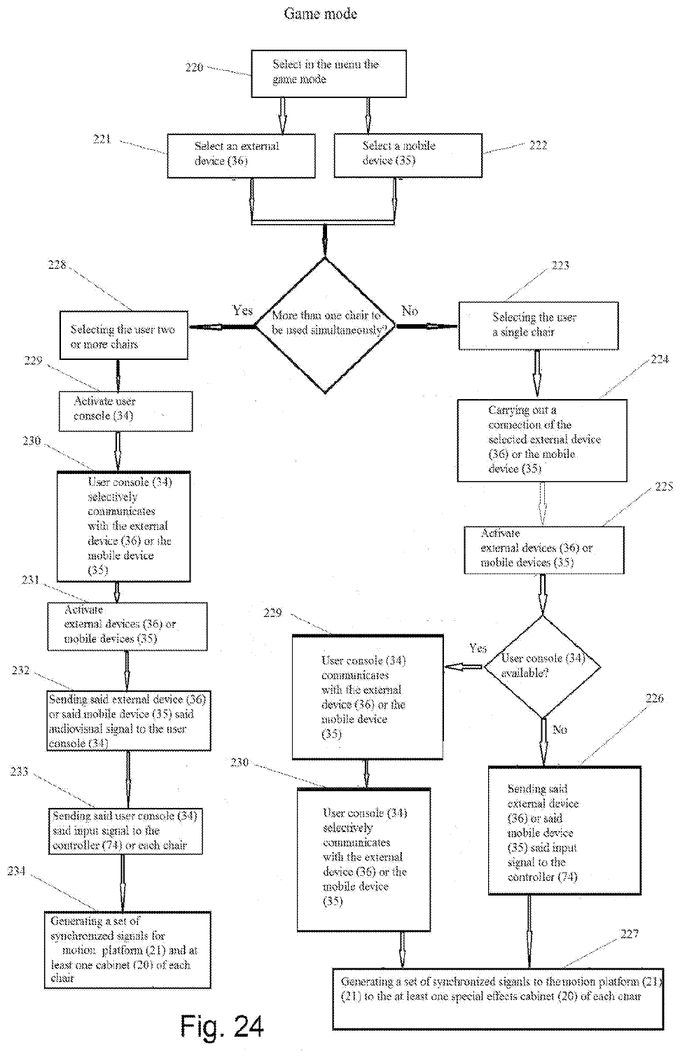

FIG. 24 shows in detail, that the gaming mode comprises in one embodiment the following steps:
(i) selecting 220 in the menu the gaming mode;
(ii) selecting 221 an external device 36 from a group formed by, but not limited to: game consoles, PCs, laptops, tablets or standalone virtual reality headsets 36, or
(iii) selecting 222 a mobile device 35 from a group formed by, but not limited to: smartphones, smartwatches, tablets or virtual reality headsets 35;
(iv) the user selects 223 a single chair 23;
(v) carrying 224 out a connection of the selected external device 36 or the selected mobile device 35 to the controller 74 of the selected chair;
(vi) activating 225 the selected external device 36 or the selected mobile device (35) to run a game to generate said audiovisual signal;
(vii) sending 226 said external device 36 or said mobile device 35 said input signal to the controller 74 based on the audiovisual signal; and
(viii) generating 227 said set of synchronized signals for movements and special effects synchronized in real time in the selected chair with an action that takes place in the game of the selected external device 36 or the selected mobile device 35.

FIG. 30 also shows in detail that the gaming mode comprises in another embodiment the following steps:
(i) selecting 220 in the menu the gaming mode;
(ii) selecting 221 an external device 36 from a group formed by, but not limited to: game consoles, PCs, laptops, tablets or standalone virtual reality headsets 36,
(iii) selecting 222 a mobile device 35 from a group formed by, but not limited to: smartphones, smartwatches, tablets or reality headsets 35;
(iv) selecting 228 the user two or more chairs;
(v) activating 229 said user console 34;
(vi) said user console 34 selectively communicates 230 with the external device 36 or the mobile device 35;
(vii) activating 231 the selected external device 36 or the selected mobile device 35 to run a game to generate said audiovisual signal;
(viii) sending 232 said external device 36 or said mobile device 35 said audiovisual signal to the user console 34 based on the audiovisual contents;
(ix) sending 233 said input signal from said user console 34 to the controller 74 of the selected chair 23 based on said audiovisual signal;
(x) generating 234 said set of synchronized signals to create movements and to create special effects synchronized in real time in the selected chairs with an action that takes place in the game of the selected external device (36) or in the game of the selected mobile device 35.

### 3. Relaxing Mode (FIGS. 5 and 6):

In the relaxing mode the user uses the chair 23 to rest and relax. The chair has a reclining system (FIG. 12) that allows to change the position of the backrest 13 and the footrest 24 so that the user can find the most comfortable position and through pre-programmed cycles that combine movements, vibrations, lights and aromas in order to generate sensations that relax and accompany them during meditation and rest. These cycles can be modified by the users to create their own unique experience. The chair uses low frequency vibrations generated by the vibration generator devices 18/25 (FIG. 1) to also generate massages. These user-adjustable pre-programmed functions combine massage (vibration effect), movement (combination of tilt and roll), aromatherapy (aroma effect) audio therapy (speakers) and chroma therapy (colored light effect). The movements, vibrations, lights and aromas can also be synchronized with audio or video content. All the programming of operation of the chair in this mode is carried out by means of the user console 34 and can also be changed from a mobile phone 33.

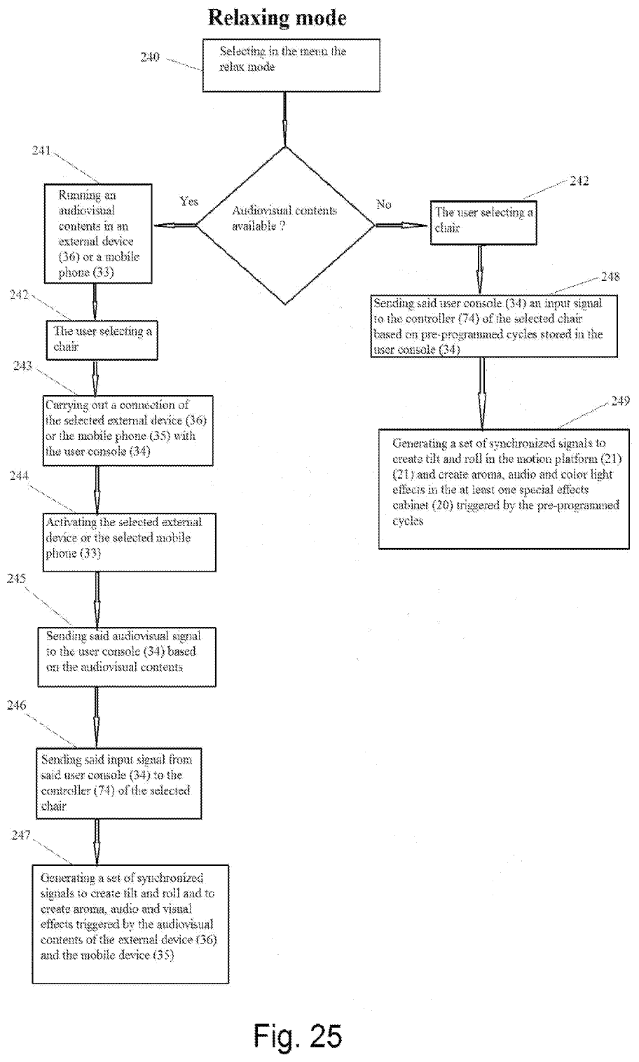

FIG. 25 shows in detail that the relaxing mode comprises in a first embodiment the following steps:
(i) selecting 240 in the menu the relaxing mode;
(ii) running 241 an audiovisual contents in a selected external device (36) or a selected mobile phone (33);
(iii) the user selecting 242 a chair 24;
(iv) carrying out a connection 243 of the selected external device 36 or the selected mobile phone 33 to the user console 34;
(v) activating 244 the selected external device 36 or the selected mobile phone 33 to generate said audiovisual signal;
(vi) sending 245 said audiovisual signal to the user console 34 based on the audiovisual contents;
(vii) sending 246 said input signal from said user console 34 to the controller 74 of the selected chair, based on said audiovisual contents;
(viii) generating 247 said set of synchronized signal to create combination of tilt and roll movement, and to create aroma effect, audio emission and colored light effect in the selected chair triggered by an action that takes place in the audiovisual content of the selected external device 36 and the mobile device 35.

FIG. 25 also shows in detail that the relaxing mode comprises in a second embodiment the following steps:
(i) selecting 240 in the menu the relaxing mode;
(ii) the user selecting 242 a chair;
(iii) sending 248 said user console 34 an input signal to the controller 74 of the selected chair based on pre-programmed cycles stored in the user console 34;
(iv) generating 249 said set of synchronized signals to create combination of tilt and roll movement, and to create aroma effect, audio emission and colored light effect in the selected chair, triggered by the pre-programmed cycles.

### 4. Simulator Mode (FIG. 4B)

In the simulator mode, the chair has also a fixed mechanical socket 22 that allows attaching a removable accessory support 37 to mount different peripherals and commercial game controllers 73, such as car steering wheels, pedals, gear shifters, airplane controls, joysticks and displays for allowing those peripherals to accompany the movement of the chair in its motion, turning the chair into a car simulator, a plane simulator, or other types of simulators.

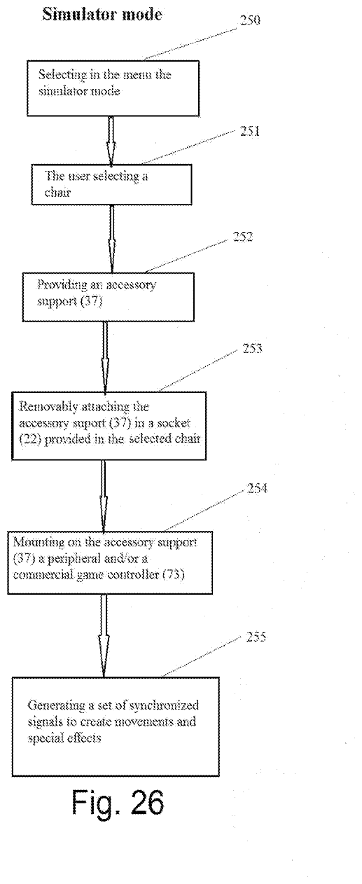

FIG. 26 shows in detail that the simulator mode comprises the steps of:
(i) selecting 250 in the menu the simulator mode;
(ii) the user selecting 251 a chair;
(iii) providing 252 an accessory support 37;
(iv) removably attaching 253 the accessory support 37 in a socket 22 provided in the selected chair;
(v) mounting 254 a peripheral and/or a commercial game controller selected from a group, but not limited to: car steering wheels, pedals, gear shifters, airplane controls, joysticks and displays 73;
(vi) generating 255 said set of synchronized signals for generating movements and special effects synchronized in real time in the selected chair with an action that takes place in the game of the selected peripheral or commercial game controller 73.

Having thus described several aspects of at least one embodiment of this disclosure, it is to be appreciated various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

1-39. (canceled)

40. An entertainment system for use with a plurality of audiovisual sources and comprising one or more special effects chairs (23); each special effects chair (23) comprising:
a body including a seat (72);
a motion platform (21) connected to the seat (72);
at least one special effects cabinet (20) contained in a portion of the body of each of the one or more chairs (23);
a controller (74) in communication with the motion platform (21), with the at least one special effects cabinet (20) for generating special effects, and with the selected audiovisual source (35, 36);
the controller (74) being configured to receive an input signal based on an audiovisual signal from the selected audiovisual source (35, 36) and to send a set of synchronized signals to the motion platform (21) and to the at least one special effects cabinet (20) in response to the received audiovisual signal, wherein each special effects cabinet (20) generates all the special effects free of requiring external special effects devices.

41. The entertainment system according to claim 40, further comprising a user console (34) configured to communicate with the selected audiovisual sources (35, 36) to receive one or more selected audiovisual signals therefrom, and to simultaneously send said input signals to the controller (74) of each of the one or more chairs in response to the audiovisual signals received from said selected audiovisual sources (35, 36).

42. The entertainment system according to claim 40, wherein each special effects cabinet (20) comprises a set of special effects generators comprising at least one of: an aroma effect generator, a water spray effect generator, a wind effect generator, a light generator, a smoke generator, an air impact effect generator and a vibrations generator;
wherein each special effects chair comprises a backrest (13) containing vibration generating devices (18) and comprises two air nozzles (17) for the air impact effect generator; and wherein each special effects chair comprises a seat (72) containing vibration generating devices (25).

43. The entertainment system according to claim 42, wherein the aroma effect generator and the air impact effect generator share an air compressor (6) for generating pressure and air volume, and wherein the air impact effect generator further comprises an air container (49).

44. The entertainment system according to claim 42, wherein the smoke effect generator shares the water tank (3) with the water spray effect generator.

45. The entertainment system according to claim 42, wherein the smoke effect generator shares the turbine blower (1) with the aroma effect generator and with the wind effect generator.

46. The entertainment system according to claim 40, wherein each chair (23) further comprises: a backrest (13), two armrests (41), a footrest (24), and a base (78), wherein said base (78) has a supportive surface that provides stability to the chair (23) against the forces exerted by the motion platform (21) over its entire range of motion, preventing the chair (23) from tipping over, thereby freeing the chair (23) from the need of being anchored to the ground or fastened to any structure.

47. The entertainment system according to claim 41, further comprising one or more environmental special effects generator boxes (173), wherein each of said one or more environmental special effects generator boxes (173) contains one or more environmental special effects generators, wherein said environmental special effects are generated in synchronism with an audio or video signal; and wherein said environmental special effects are generated entirely within the one or more environmental special effects generator boxes (173) in an autonomous way, that is, free of requiring external devices.

48. The entertainment system according to claim 47, wherein said one or more environmental special effects generator boxes (173) receive the synchronization signal to generate said environmental special effects from said user console (34) or from at least one external device; wherein said at least one external device is selected from the group formed by, but not limited to: PCs, laptops, smartphones, smartwatches, tablets and game consoles (36).

49. The entertainment system according to claim 47, wherein the user console (34) is configured to communicate with devices selected from the group formed by, but not limited to: said chairs, said one or more environmental special effects boxes (173), and audiovisual sources comprising external devices selected from a group formed by, but not limited to: PCs, laptops, game consoles, smartphones, smartwatches, tablets and virtual reality headsets (35, 36).

50. The entertainment system according to claim 47 wherein the user console (34) is configured to store and play-back audio and video content, run video game software and store pre-programmed cycles to produce movements and to trigger special effects, in the one or more chairs.

51. The entertainment system according to claim 47, wherein the user console (34) communicates through an internet connection with digital platforms of audio and video contents.

52. The entertainment system according to claim 47, wherein the user console (34) is configured to create and edit movement schedules and to create and edit timing sequences of special effects trigger commands for the one or more chairs, and is configured for allowing the entertainment system to share said schedules and sequences with other identical entertainment systems in other locations, via the internet or mobile phone communications.

53. The entertainment system according to claim 46, wherein each of the motion platform (21), the backrest (13), the seat (72), the armrests (41), the special effects cabinet (20), the electronic controller unit (74) and the base (78) form altogether an electrically and mechanically linked device, said one or more special effects chairs being free from the need of being assembled by a user and free of the need of a special electrical or mechanical infrastructure for their operation, making it suitable for its use in a home.

54. The entertainment system according to claim 40, wherein each chair (23) is configured to operate in three different hardware configurations: (i) configuration with a user console (34); (ii) configuration with a PC or a game console; (iii) configuration with a mobile device.

55. The entertainment system according to claim 54,
(i) wherein the hardware configuration with a user console (34) includes at least one chair (23) connected to a user console (34); and comprises communication with a display device (29) selected from the group consisting of, but not limited to: TV, smart TV, monitor, video projector and virtual reality headset;
(ii) wherein in the hardware configuration with a PC or a game console, the one or more chairs are connected to the PC or game console; and
(iii) wherein in the hardware configuration with a mobile device, the one or more chairs are connected directly to a mobile device selected from the group consisting of, but not limited to: smartphones and smartwatches, tablets and virtual reality headsets (35).

56. The entertainment system according to claim 40, wherein each of the one or more chairs further comprises a socket (22); wherein said socket (22) is configured for the mounting of a removable accessory support (37) for attaching different peripherals and commercial controls for software simulators and video games, selected from the group formed by, but not limited to: steering wheels, pedals, gear-shifters, airplane controls, joysticks and displays; and for allowing those said peripherals and game controls to accompany the movement of the chair (23) in its motion, turning the chair (23) into a simulator with movements and effects.

57. The entertainment system according to claim 47, wherein the special effects are generated by the special effects cabinet (20) or the environmental special effects box (173), or both (20, 173).

58. A special effects chair (23) for use with a plurality of audiovisual sources, the chair (23) comprising:
a body including a seat (72);
a motion platform (21) connected to the seat (72); and
at least one special effects cabinet (20) housed in a portion of the body of the chair (23) and including a controller (74) configured to selectively communicate with one of the plurality of audiovisual sources (36), said controller (74) being in communication with the motion platform (21), with the at least one special effects cabinet (20) and with the selected audiovisual source (36), the controller (74) being configured to receive an input signal based on an audiovisual signal from the selected audiovisual source (36) and to send a set of synchronized signals to the motion platform (21) and to the at least one special effects cabinet (20) in response to the received audiovisual signal;
wherein each special effects cabinet (20) generates all the special effects free of requiring external special effects devices.

59. An environmental special effects box (173) for use with a plurality of audiovisual sources, and with a user console (34), the environmental special effects box (173) comprising:
a set of environmental special effects generators; a controller (111) configured to selectively communicate with one of the plurality of audiovisual sources (36) and with the user console (34), said controller (111) being configured to receive an input signal based on an audiovisual signal from the selected audiovisual source (36) or from the user console (34) and to send a set of synchronized signals to the set of environmental special effects contained therein in response to the received audiovisual signal or the received signal from the console (34);
wherein said set of environmental special effect generators contained in each of the one or more environmental special effects generator boxes (173) comprise at least one of: an environmental smoke effect generator, an environmental light effect generator, an environmental wind effect generator, an environmental aroma effect generator, an environmental water spray effect generator, and environmental smoke effect generator;
wherein said environmental smoke effect generator comprises a water tank (103) to store water, and wherein the water tank (103) contains an ultrasonic transducer (163) inserted into a floating device (164) and wherein the ultrasonic transducer (163) vibrates at an ultrasonic frequency breaking the water particles in the water tank (103) to generate mist that simulates smoke; and wherein the environmental smoke effect generator also comprises a turbine blower (101) that pushes the mist to an air outlet port (102) of the environmental special effects box (173);
wherein the set of environmental special effects generators generates all the environmental special effects free of external special effects devices.

60. The environmental special effects box according to claim 59, wherein the environmental smoke effect generator shares the water tank (103) with the environmental water spray effect generator.

61. The environmental special effects box according to claim 59, wherein the environmental smoke effect generator shares the turbine blower (101) with the environmental aroma effect generator and with the environmental wind effect generator.

62. A method of providing a special effects system for use with a plurality of audiovisual sources, the system comprising one or more chairs; each chair having a seat (72), a backrest (13) and a footrest (24), a motion platform (21) connected to the seat, at least one special effects cabinet (20) contained in the chair (23) and a user console (34) configured to selectively communicate with one of the plurality of audiovisual sources, and including a controller (74) in communication with the motion platform (21), with the at least one special effects cabinet (20) and with the user console (34); wherein the user console (34) is configured to selectively communicate with one of the plurality of audiovisual sources (35, 36); the method comprising:
providing (200) a menu to a user to select (201) a mode from: a cinema mode, a gaming mode, a relaxing mode, and a simulator mode; and
causing (204) the controller (74) to send a set of synchronized signals to the motion platform (21) and to the at least one special effects cabinet (20) in response to an input signal based on an audiovisual signal received (203) from the user console (34) and the selected mode; or in response to an input signal based on an audiovisual signal received (202) from the selected audiovisual source (35, 36) and the selected mode.

63. The method of claim 62,
wherein in the cinema mode, each chair (23) moves its motion platform (21) and activates the one or more special effects cabinets (20) in synchronism with audiovisual content, according to a previously programmed and encoded sequence;
wherein, in the gaming mode, each chair (23) communicates through different protocols with an external device selected from a group formed by, but not limited to: PCs, laptops, game consoles, smartphones, smartwatches, tablets and virtual reality headsets (36) and generates movements and special effects synchronized in real time with the action that takes place within the game;
wherein, in the relaxing mode, each chair (23) changes the ergonomic position of its backrest (13) and footrest (24) and, triggered from an external device (36) or a mobile device (35), or through pre-programmed cycles, it generates movements, vibrations, lights and aromas in relaxation routines; and
wherein, in the simulator mode, the user mounts a removable accessory/support (37) to the chair (23); wherein said accessory/support (37) allows mounting different peripherals and commercial game controls, selected from the group consisting of, but not limited to: steering wheels, pedals, gear shifters, airplane controls, joysticks and displays; and for allowing those said peripherals and game controls to accompany the movement of the chair (23) in its motion, turning the chair (23) into a simulator with movements and effects, wherein the entertainment system is designed to be used in a household setting.
